(19) United States
(12) Patent Application Publication
(10) Pub. No.: US 2007/0195080 A1
(43) Pub. Date: Aug. 23, 2007

(54) Apparatus and method for driving a display panel

(76) Inventor: Ju-Hyun Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/655,220

(22) Filed: Jan. 19, 2007

(30) Foreign Application Priority Data
Feb. 20, 2006 (KR) 10-2006-0016239

(51) Int. Cl. G09G 5/00

(52) U.S. Cl. 345/211

(57) ABSTRACT

An apparatus that drives a display panel by applying voltages from two or more voltage sources to a plurality of electrodes, includes a voltage converting unit receiving two or more input voltages, converting the input voltages into at least one output voltages, and outputting the output voltages, and an output controller outputting the output voltages after all the input voltages have reached a specific level.

### BACKGROUND OF THE INVENTION

1. Field of the Invention

The present invention relates to a method and apparatus for driving a display panel. More particularly, the present invention relates to a method and apparatus for driving a display panel by generating predetermined voltage with a dc-to-dc converter that generates output voltages from two or more input voltages.

2. Description of the Related Art

Plasma display panels (PDPs) have come to public attention because they can be easily manufactured as large, flat panel displays. Current focus is on the development of AC type PDPs.

Generally, an AC type PDP may include three electrodes driven by AC voltages. The PDP may include a plurality of display cells formed in an area where sustain electrodes intersect address electrodes. Each display cell typically includes three, e.g., red, green, and blue, discharge cells. Gray scale of an image may be represented by adjusting discharge states of the discharge cells.

In order to represent gray scale on the PDP, a frame applied to the PDP may be divided into eight subfields having different light-emitting frequencies, thereby representing 256 gray scales. That is, in order to display an image with 256 gray scales, a frame period (16.67 ms) corresponding to 1/60 seconds may be divided into eight subfields. Each of the subfields may have a reset period, an address period, and a sustain-discharge period to drive the PDP.

Voltages may be applied to electrodes in the reset period, the address period, and the sustain-discharge period using an apparatus that drives the PDP. In particular, a large-scale PDP requires a plurality of power levels. Thus, to generate power, the large-scale PDP may further include a dc-to-dc converter, in addition to a switching mode power supply (SMPS) of a power supply unit.

To generate a plurality of voltage levels, two or more input voltages may be applied to the dc-to-dc converter, and output voltages may be generated from the applied input voltages. However, a length of time that the respective applied voltages reach a specific level may not be the same. Thus, a length of time before dc-to-dc converter starts to operate may not be uniform. In this case, an output sequence may vary, and the dc-to-dc. converter may be stressed during a time interval between a first input voltage and a second input voltage being applied thereto.

### SUMMARY OF THE INVENTION

The present invention is therefore directed to an apparatus and method for driving a PDP, which substantially overcome one or more of the problems due to the limitations and disadvantages of the related art.

It is therefore a feature of an embodiment of the present invention to provide a display panel driving apparatus and method in which when two or more input voltages are applied to a dc-to-dc converter, all the output voltages are simultaneously output after all the input voltages have reached a specific level.

It is another feature of an embodiment of the present invention to provide a display panel driving apparatus and method that reduces or prevents a circuit from suffering from stress caused by an output sequence difference.

At least one of the above and other features and advantages of the present invention may be realized by providing an apparatus for driving a display panel by applying voltages from two or more voltage sources to a plurality of electrodes, the apparatus including a voltage converting unit receiving two or more input voltages, converting the input voltages into at least one output voltage, and outputting the output voltage(s), and an output controller outputting the output voltages after all the input voltage(s) have reached a specific level.

The input voltages and the output voltages may be dc voltages, and the voltage converting unit may change the levels of the input voltages.

The output controller may receive the input voltages and the output voltages, and output the output voltages after all the input voltages have reached the specific level. The output voltages may be simultaneously output from the output controller.

The output controller may include an input unit receiving and normalizing the input voltages, a determination unit receiving the normalized voltages from the input unit and determining whether all the input voltages have reached the specific level, and an output unit outputting the output voltages when the determination unit determines that all the input voltages have reached the specific level.

The input unit may include a first input terminal to which a first-level input voltage is applied, a second input terminal to which a second-level input voltage is applied, and a reference voltage input terminal to which a reference voltages is applied. The input unit may include two or more resistors connected in series between one of the first and second input terminals and a ground terminal, the first and second input voltages being normalized through voltage distribution according to a resistance value of resistors connected in series. The input terminal may include two or more resistors connected in series between the reference voltage input terminal and the ground terminal, so that the reference voltage is normalized through voltage distribution according to a resistance value of the resistors connected in series.

The determination unit may include a first comparator comparing a voltage received from the first input terminal with the reference voltage, and a second comparator comparing a voltage received from the second input terminal with the reference voltage. The determination unit may further include a determinator outputting an output control signal that allows all the output voltages to be output from the output unit when all signals output from the first and second comparators are on.

The determination unit may output an on/off output control signal according to whether all the input voltages have reached the specific level. The output unit may include one or more switching devices being on or off in response to the output control signal. The switching device may be an npn-type transistor that allows the output voltages to be output when the output control signal is off.

The apparatus may include a logic controller generating driving control signals according to an image signal to be displayed, where the driving control signals comprise an X driving control signal, a Y driving control signal, and an A driving control signal, an X driver processing the X driving control signal and applying the processed result to X-electrodes, a Y driver processing the Y driving control signal and applying the processed result to Y electrodes, and an address driver processing the A driving control signal and applying the processed result to address electrodes. The voltage converting unit and the output controller may be included in at least one of the X driver, the Y driver, and the address driver.

At least one of the above and other features and advantages of the present invention may be realized by providing a method of driving a display panel by applying voltages from two or more voltage sources to a plurality of electrodes, the method including receiving two or more input voltages, determining whether all the input voltages reach a specific level, converting the input voltages into two or more output voltages, and outputting the output voltages after all the input voltages reach the specific level.

The input voltages and the output voltages may be dc voltages, and converting the input voltages may include changing the input voltages. The output voltages may be simultaneously output.

The input voltages may include a first-level first voltage, a second-level second voltage, and a reference voltage, wherein determining includes comparing the reference voltage with each of the first and second voltages. Before comparing, the input voltages may be normalized, e.g., by distributing the input voltages through two or more resistors connected in series.

The method may include outputting an on/off output control signal according to whether all the input voltages have reached the specific level. When all the input voltages reach the specific level, an output control signal allowing all the output voltages to be output may be output.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a schematic diagram of an apparatus for driving a plasma display panel in accordance with an exemplary embodiment of the present invention;

FIG. 2 illustrates a schematic circuit diagram of a voltage converting unit and an output controller included in the apparatus of FIG. 1 according to an exemplary embodiment of the present invention;

FIG. 3 illustrates a schematic circuit diagram of an internal structure of the output controller illustrated in FIG. 3 according to an exemplary embodiment of the present invention; and

FIG. 4 illustrates a schematic flowchart of a method of driving a plasma display panel according to an exemplary embodiment of the present invention.

### DETAILED DESCRIPTION OF THE INVENTION

Korean Patent Application No. 10-2006-0016239, filed on Feb. 20, 2006, in the Korean Intellectual Property Office, and entitled: “Apparatus and Method for Driving Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

Hereinafter, a plasma display panel, as an exemplary type of display, according to an embodiment of the present invention will be described in greater detail with reference to the accompanying drawings.

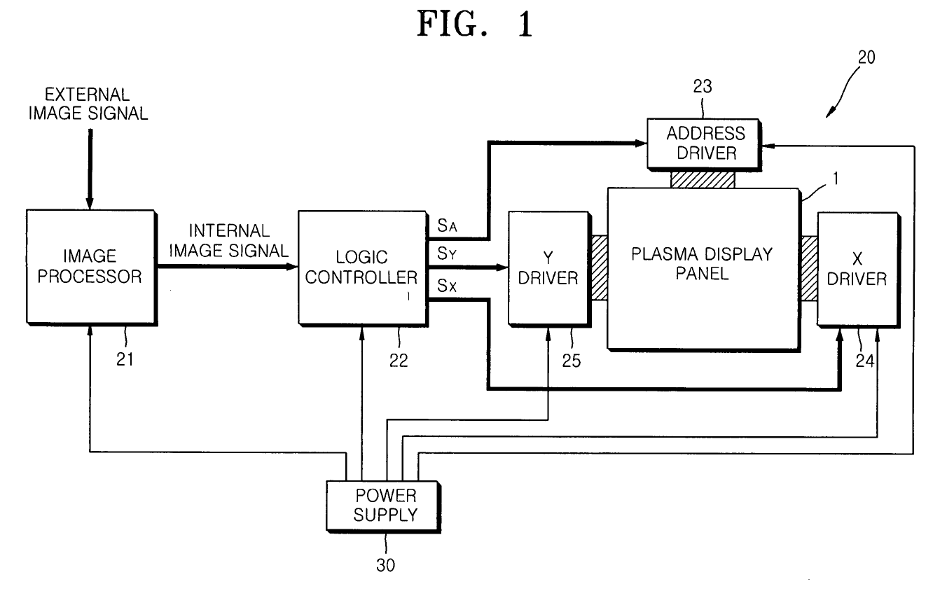

FIG. 1 illustrates a schematic block diagram of a driving apparatus 20 that drives a PDP 1 according to an embodiment of the present invention. Referring to FIG. 1, the driving apparatus 20 may include an image processor 21, a logic controller 22, an address driver 23, an X driver 24, and a Y driver 25. A power supply 30, e.g., a switching mode power supply (SMPS), may supply voltages to the components of the driving apparatus 20.

The image processor 21 may convert external analog image signals into digital signals to generate internal image signals. The internal image signals may be red (R), green (G), and blue (B) image data signals. Each data signal may have 8 bits, a clock signal, and vertical and horizontal synchronization signals. The logic controller 22 may generate driving control signals S_{A}, S_{Y}, and S_{X} from the internal image signals received from the image processor 21.

The address driver 23, the X driver 24, and the Y driver 25 may receive the driving control signals S_{A}, S_{Y}, and S_{X}, may generate driving signals and may apply them to corresponding electrodes (not shown) of the PDP 1, respectively.

That is, the address driver 23 may process the address driving control signal S_{A} received from the logic controller 22, generate a display data signal, and apply the display data signal to address electrodes. The X driver 24 may process the X driving control signal S_{X} from the logic controller 22, and apply the resultant signal to X electrodes. The Y driver 25 may process the Y driving control signal S_{Y} from the logic controller 22 and apply the resultant signal to the Y electrodes. Details of a driving a display using the apparatus may be found, for example, in U.S. Pat. No. 6,744,218, which is incorporated herein by reference in its entirety.

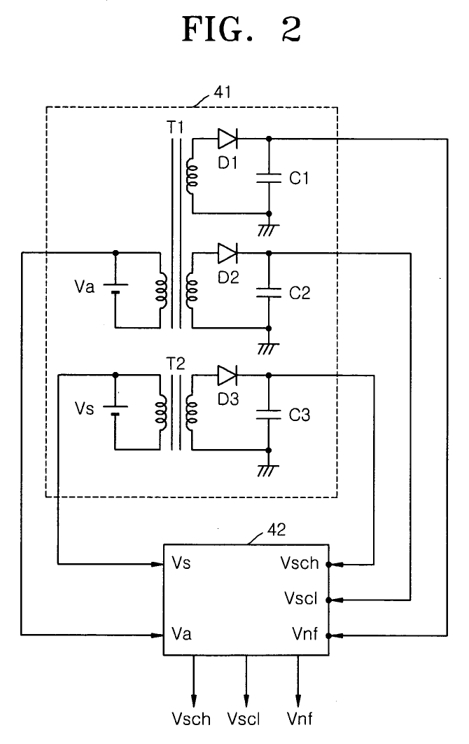

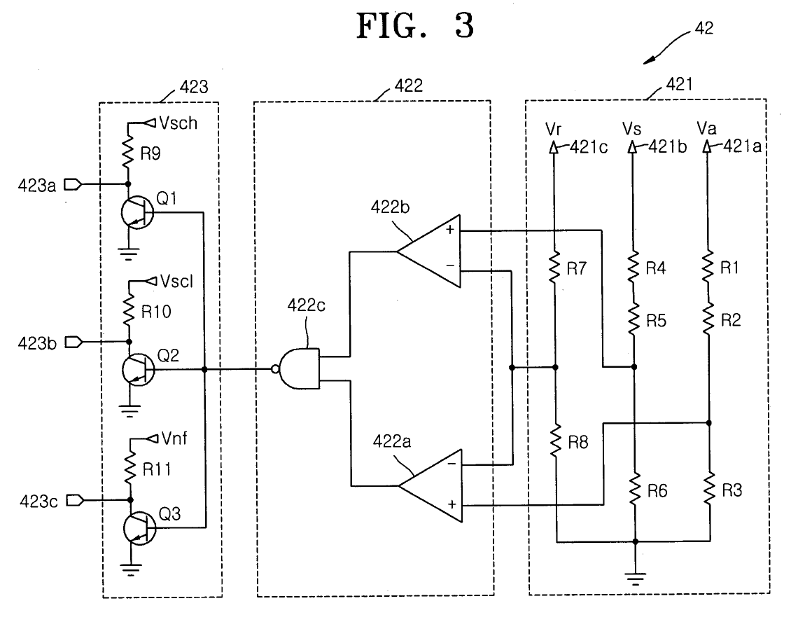

FIG. 2 illustrates a schematic circuit diagram of a voltage converting unit 41 and an output controller 42 that may be included in the driving apparatus 20 illustrated in FIG. 1 according to an embodiment of the present invention. FIG. 3 illustrates a schematic circuit diagram of the internal structure of the output controller 42 illustrated in FIG. 2 according to an embodiment of the present invention.

Referring to FIGS. 2 and 3, the driving apparatus 20, which drives a display panel (not shown) by applying voltages from two or more voltage sources to a plurality of electrodes, may include the voltage converting unit 41 and the output controller 42.

The voltage converting unit 41 may receive, e.g., first and second input voltages, e.g., an address voltage Va and a sustain voltage Vs, convert them into, e.g., first through third output voltages, e.g., a scan high voltage Vsch, a scan low voltage Vscl, and a minimum Vnf, and output the output voltages Vsch, Vscl, and Vnf. The output controller 42 may output the output voltages Vsch, Vscl, and Vnf after all the input voltages Va and Vs input to the output controller 42 have reached a specific level. The input voltages Va and Vs, and the output voltages Vsch, Vscl, and Vnf may be dc voltages, and the levels of the input voltages Va and Vs may be changed by the voltage converting unit 41.

The voltage converting unit 41 may receive the dc input voltages Va and Vs, and may change them to the dc output voltages Vsch, Vscl, and Vnf. In the voltage converting unit 41, dc-to-dc conversion may be performed by first and second converters T1 and T2. In an embodiment of the present invention, the first and second converters T1 and T2 may convert the first input voltage Va and the second input voltage Vs into the first output voltage Vsch, the second output voltage Vscl, and the third output voltage Vnf.

The first converter T1 may convert the first input voltage Va into the second output voltage Vscl and the third output voltage Vnf. An output terminal of the first converter T1 may be connected to diodes D1 and D2, and to capacitors C1 and C2. The second converter T2 may convert the second input voltage Vs into the first output voltage Vsch. An output terminal of the second converter T2 may be connected to a diode D3 and a capacitor C3.

The output controller 42 may output all the output voltages Vsch, Vscl, and Vnf after all the input voltages Va and Vs reach the specific level. The output controller 42 may receive the input voltages Va and Vs, and the output voltages Vsch, Vscl, and Vnf, and may output the output voltages Vsch, Vscl, and Vnf. The output voltages Vsch, Vscl, and Vnf may be output after all the input voltages Va and Vs reach the specific level. The output voltages Vsch, Vscl, and Vnf may be simultaneously output from the output controller 42.

The output controller 42 may include an input unit 421, a determination unit 422, and an output unit 423. The input unit 421 may receive the input voltages Va and Vs, and may normalize them. The determination unit 422 may receive the normalized voltages from the input unit 421, and may determine whether all the input voltages Va and Vs reach the specific level. The output unit 423 may output the output voltages Vsch, Vscl, and Vnf when the determination unit 422 determines that all the input voltages Va and Vs reach the specific level.

The input unit 421 may include a first input terminal 421a, a second input terminal 421b, and a reference voltage input unit 421c. The first voltage Va having a first level may be applied to the first input terminal 421a. The second input voltage Vs having a second level may be applied to the second input terminal 421b. A reference voltage Vr may be applied to the reference voltage input terminal 421c to determine whether the first and second voltages Va and Vs reach the specific level.

The input unit 421 may include two or more resistors R1 through R8, respectively connected in series between a corresponding voltage input terminal 421a, 421b, or 421c, and a ground voltage. That is, the input voltages Va and Vs and the reference voltage Vr may be normalized through voltage distribution according to a resistance value of the resistors connected in series.

Specifically, the resistors R1 through R3 may be connected in series between the first input terminal 421a and the ground terminal, and the normalized voltage may be applied to a first comparator 422a through voltage distribution performed by the resistors R1 through R3. The resistors R4 through R6 may be connected in series between the second input terminal 421b and the ground terminal, and the normalized voltage may be applied to a second comparator 422b through voltage distribution performed by the resistors R4 through R6. The resistors R7 and R8 may be connected in series between the reference voltage input terminal 421c and the ground terminal, and the normalized voltage may be applied to the first and second comparators 422a and 422b through voltage distribution performed by the resistors R7 and R8.

The determination unit 422 may receive the normalized voltages from the input unit 421, and may determine whether all the input voltages Va and Vs reach the specific level. To realize this, the determination unit 422 may include the first and second comparators 422a and 422b and a determinator 422c.

The first comparator 422a may compare a voltage received from the first input terminal 421a with the reference voltage Vr. A voltage applied to the first input terminal 421a may be normalized through voltage distribution performed by the resistors R1 through R3 connected in series, and a voltage applied to the reference voltage input terminal 421c may be normalized through voltage distribution performed by the resistors R7 and R8 connected in series.

The second comparator 422b may compare a voltage received from the second input terminal 421b with the reference voltage Vr. A voltage applied to the second input terminal 421b may be normalized through voltage distribution performed by the resistors R4 through R6 connected in series, and a voltage applied to the reference voltage input terminal 421c may be normalized through voltage distribution performed by the resistors R7 and R8 connected in series.

An on/off output control signal may be output from the determination unit 422 according to whether all the input voltages Va and Vs have reached the specific level. In an embodiment of the present invention, when the output control signal is an off signal, output voltages may be output. For this end, the determination unit 422 may include a determinator 422c, and in embodiments, the determinator 422c may be a NAND gate. The determinator 422c may be connected to output terminals of the first and second comparators 422a and 422b. Thus, when all signals output from the first and second comparators 422a and 422b are on, the output control signal output from the determinator 422c allows the output voltages Vsch, Vscl, and Vnf to be output from the output unit 423.

The voltage converting unit 41 may then convert the input voltages Va and Vs into the output voltages, and output the input voltages Va and Vs and the output voltages Vsch, Vscl, and Vnf to the output controller 42. More particularly, all the output voltages Vsch, Vscl, and Vnf may be simultaneously output from the output unit 423 of the output controller 42 when the determination unit 422 determines that the input voltages Va and Vs have reached the specific level. The output unit 423 may include switching devices Q1, Q2, and Q3 that may be switched on or off in response to the output control signal. The switching devices Q1, Q2, and Q3 may be npn-type transistors to output the output voltages Vsch, Vscl, and Vnf when the output control signal is an off signal.

Accordingly, when the input voltages Va and Vs have reached a specific level, the output voltages Vsch, Vscl, and Vnf may be simultaneously output from the output controller 42.

The voltage converting unit 41 and the output controller 42 may be included in either the power supply 30, or in at least one of the X driver 24, the Y driver 25, and the address driver 23. In an embodiment of the present invention, the voltage converting unit 41 and the output controller 42 may be included in the Y driver 25. Thus, input voltages Va and Vs may be applied to the voltage converting unit 41 and the output controller 42, and the output voltages Vsch, Vscl, and Vnf may be output from the output controller 42.

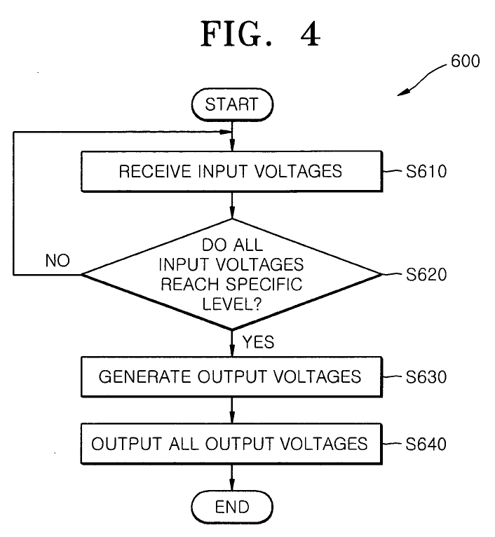

FIG. 4 illustrates a schematic flowchart of a method 600 of driving a plasma display panel according to an embodiment of the present invention. Referring to FIG. 4, in the method 600, a display panel may be driven by applying voltages from two or more voltage sources to a plurality of electrodes. The method 600 may include receiving input voltages (S610), an input voltage determination operation (620), converting the voltages (S630), and outputting output voltages (S640). In an embodiment of the present invention, the method S600 may be performed by the driving apparatus 20 illustrated in FIGS. 2 and 3.

In operation S610, two or more input voltages (e.g., the input voltages Va and Vs illustrated in FIG. 2) may be received. In operation S620, it may be determined whether all the input voltages Va and Vs have reached a specific level. In operation S630, the input voltages Va and Vs may be converted into two or more output voltages, e.g., Vsch, Vscl, and Vnf illustrated in FIG. 2. In operation S640, the output voltages Vsch, Vscl, and Vnf may be output simultaneously after all the input voltages Va and Vs reach the specific level. The input voltages Va and Vs and the output voltages Vsch, Vscl, and Vnf may be dc voltages, and the input voltages Va and Vs may be converted in operation S630.

The input voltages received in operation S610 may include the first input voltage Va having a first level and the second input voltage Vs having a second level. Also, the input voltages may include a reference voltage Vr to be compared with the first and second voltages Va and Vs. In operation S620, the input voltages Va and Vs and the reference voltage Vr may be received and normalized. The input voltages Va and Vs and the reference voltage Vr may be normalized through voltage distribution using resistors connected in series, as illustrated in FIG. 3.

In operation S620, whether the first and second input voltages Va and Vs reach the specific level may be determined by comparing the first and second voltages Va and Vs with the reference voltage Vr, e.g., by comparing normalized first and second voltages Va and Vs, and the normalized reference voltage Vr.

Also, in operation S620, an on/off output control signal may be output according to whether all the input voltages Va and Vs reach the specific level as described with reference to FIG. 3. Specifically, when all the input voltages Va and Vs reach the specific level, the off output control signal that allows all the output voltages Vsch, Vscl, and Vnf to be output may be output. In operation S640, when the output control signal is an off signal, the output voltages Vsch, Vscl, and Vnf may be simultaneously output. In this case, npn type transistors may be used as described with reference to FIG. 3.

In operation S630, the input voltages Va and Vs may be transformed into the output voltages Vsch, Vscl, and Vnf illustrated in FIG. 2. The conversion of the input voltages Va and Vs may be performed by using the voltage converting unit 41 illustrated in FIG. 2, which is a dc-to-dc converter.

Accordingly, when two or more input voltages are applied to a dc-to-dc converter, output voltages Vsch, Vscl, and Vnf may be simultaneously output after all input voltages Va and Vs reach a specific level, thereby preventing the circuit from suffering from stress caused by an output sequence difference.

In an apparatus and method for driving a display panel according to the present invention, when two or more input voltages are applied to a dc-to-dc converter, output voltages may be simultaneously output from the dc-to-dc converter after all the input voltages reach a specific level, thereby preventing the circuit from suffering from stress caused by an output sequence difference.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An apparatus for driving a display panel by applying voltages from two or more voltage sources to a plurality of electrodes, the apparatus comprising:
a voltage converting unit receiving two or more input voltages, converting the input voltages into at least one output voltage, and outputting the output voltages; and
an output controller outputting the output voltages after all the input voltages have reached a specific level.

2. The apparatus as claimed in claim 1, wherein the input voltages and the output voltages are dc voltages, and
the voltage converting unit changes levels of input voltages.

3. The apparatus as claimed in claim 1, wherein the output controller receives the input voltages and the output voltages, and outputs the output voltages after all the input voltages have reached the specific level.

4. The apparatus as claimed in claim 3, wherein the output voltages are simultaneously output from the output controller.

5. The apparatus as claimed in claim 1, wherein the output controller comprises:
an input unit receiving and normalizing the input voltages;
a determination unit receiving the normalized voltages from the input unit and determining whether all the input voltages have reached the specific level; and
an output unit outputting the output voltages when the determination unit determines that all the input voltages have reached the specific level.

6. The apparatus as claimed in claim 5, wherein the input unit comprises:
a first input terminal to which a first-level input voltage is applied;
a second input terminal to which a second-level input voltage is applied; and
a reference voltage input terminal to which a reference voltages is applied.

7. The apparatus as claimed in claim 6, wherein the input unit further comprises two or more resistors connected in series between one of the first and second input terminals and a ground terminal, the first and second input voltages being normalized through voltage distribution according to a resistance value of the resistors connected in series.

8. The apparatus as claimed in claim 7, wherein the input unit further comprises two or more resistors connected in series between the reference voltage input terminal and the ground terminal so that the reference voltage is normalized through voltage distribution according to a resistance value the resistors connected in series.

9. The apparatus as claimed in claim 6, wherein the determination unit comprises:
a first comparator comparing a voltage received from the first input terminal with the reference voltage; and
a second comparator comparing a voltage received from the second input terminal with the reference voltage.

10. The apparatus as claimed in claim 9, wherein the determination unit further comprises a determinator outputting an output control signal that allows all the output voltages to be output from the output unit when all signals output from the first and second comparators are on.

11. The apparatus as claimed in claim 5, wherein the determination unit outputs an on/off output control signal according to whether all the input voltages have reached the specific level.

12. The apparatus as claimed in claim 11, wherein the output unit comprises one or more switching devices being on or off in response to the output control signal.

13. The apparatus as claimed in claim 12, wherein the switching device is an npn-type transistor that allows the output voltages to be output when the output control signal is off.

14. The apparatus as claimed in claim 1, further comprising:
a logic controller generating driving control signals according to an image signal to be displayed, where the driving control signals comprise an X driving control signal, a Y driving control signal, and an A driving control signal;
an X driver processing the X driving control signal and applying the processed result to X-electrodes;
a Y driver processing the Y driving control signal and applying the processed result to Y electrodes; and
an address driver processing the A driving control signal and applying the processed result to address electrodes.

15. The apparatus as claimed in claim 14, wherein the voltage converting unit and the output controller are included in at least one of the X driver, the Y driver, and the address driver.

16. A method of driving a display panel by applying voltages from two or more voltage sources to a plurality of electrodes, the method comprising:
receiving two or more input voltages;
determining whether all the input voltages reach a specific level;
converting the input voltages into two or more output voltages; and
outputting the output voltages after all the input voltages reach the specific level.

17. The method as claimed in claim 16, wherein the input voltages and the output voltages are dc voltages, and converting the input voltages includes changing the input voltages.

18. The method as claimed in claim 16, wherein outputting includes simultaneously outputting the output voltages.

19. The method as claimed in claim 16, wherein the input voltages include a first-level first voltage, a second-level second voltage, and a reference voltage, wherein determining includes comparing the reference voltage with each of the first and second voltages.

20. The method as claimed in claim 19, further comprising, before comparing, normalizing the input voltages.

21. The method as claimed in claim 20, wherein normalizing includes distributing the input voltages through two or more resistors connected in series.

22. The method of claim 19, wherein determining includes comparing the first and second voltages with the reference voltage to determine whether the first and second voltages reach the specific level.

23. The method as claimed in claim 16, wherein outputting includes outputting an on/off output control signal according to whether all the input voltages reach the specific level.

24. The method as claimed in claim 23, wherein, when all the input voltages reach the specific level, outputting an output control signal allowing all the output voltages to be output.
